(19) United States
(12) Patent Application Publication
(10) Pub. No.: US 2007/0199422 A1
(43) Pub. Date: Aug. 30, 2007

(54) Sheet cutting device, printer, and sheet cutting method

(76) Inventor: Kouji Kawaguchi, Chiba-shi (JP)

Correspondence Address: BRUCE L. ADAMS, ESQ., SUITE 1231, 17 BATTERY PLACE, NEW YORK, NY, 10004, US

(21) Appl. No.: 11/705,699

(22) Filed: Feb. 13, 2007

(30) Foreign Application Priority Data
Feb. 28, 2006 (JP) 2006-052218

(51) Int. Cl. B26D 1/08

(52) U.S. Cl. 83/583; 83/636

(57) ABSTRACT

Durability of cutting performance of a fixed blade and a movable blade is increased to downsize a device as a whole and to reduce manufacture costs thereof. The device includes a flat fixed blade (21), a flat movable blade (22) having a blade edge allowed to perform horizontal movement with respect to the fixed blade (21) in directions approaching and departing from a blade edge of the fixed blade (21), a drive mechanism (23) for moving the movable blade (22) with respect to the fixed blade (21), and spacers (28) for forming a predetermined gap according to a thickness of a sheet material (5) between the blade edges (21a) and (22a) in a thickness direction of those when the blade edges (21a) and (22a) of the fixed blade (21) and the movable blade (22), respectively, intersect with each other.

### BACKGROUND OF THE INVENTION

1. Field of the Invention

The present invention relates to a sheet cutting device for cutting a sheet material by a fixed blade and a movable blade after performing printing on the sheet material such as roll paper, a printer including the sheet cutting device, and to a sheet cutting method.

2. Description of the Related Art

Conventionally, there has been known a printer for performing printing on the sheet material such as roll paper and cutting the sheet material. The conventional printer of this type includes a printing device for performing printing on the sheet material and a sheet cutting device for cutting the sheet material on which printing is performed by the printing device.

The conventional sheet cutting device includes a fixed blade, a movable blade, and a drive mechanism for driving the movable blade with respect to the fixed blade.

In the conventional sheet cutting device, the movable blade is brought into press contact with the fixed blade by an urging member such as a coil spring. In a state where blade edges of the fixed blade and the movable blade are brought into press contact with each other, the fixed blade and the movable blade are allowed to intersect with each other, thereby cutting the sheet material (see, for example, JP 11-123692 A).

With regard to the sheet cutting device structured as described above, an operation of cutting the sheet material by the fixed blade and the movable blade will be described with reference to the drawings.

As shown in FIG. 11A, the sheet cutting device has such a structure that in a waiting state where a movable blade 122 is spaced apart from a fixed blade 121, a position of a blade edge 121a of the fixed blade 121 overlaps a position of a blade edge 122a of the movable blade 122 in a thickness direction of those, that is, a conveying direction of a sheet material 105 by an overlap amount d.

The drive mechanism allows the movable blade 122 to perform horizontal movement with respect to the fixed blade 121 in a direction of an arrow b1, thereby, as shown in FIG. 11B, allowing the fixed blade 121 to rotate in a direction of an arrow a2 against an elastic force of a compression coil spring 123.

Subsequently, as shown in FIG. 1C, the movable blade 122 further moves in the direction of the arrow b1, thereby allowing the blade edge 121a of the fixed blade 121 to slide along an opposing surface of the movable blade 122. Then, the blade edge 121a of the fixed blade 121 intersects with the blade edge 122a of the movable blade 122 while being brought into contact with each other, thereby cutting the sheet material 105. At this time, cutting of the sheet material 105 cut by the blade edges 121a and 122a of the fixed blade 121 and the movable blade 122, respectively, is started at the opposite sides in a width direction thereof and is smoothly performed from the opposite sides toward the center thereof.

After cutting the sheet material 105, as shown in FIG. 11D, the movable blade 122 is moved in a direction of an arrow b2, thereby allowing the blade edge 121a of the fixed blade 121 along the opposing surface of the movable blade 122. As shown in FIG. 11e, as the movable blade 122 is moved in the direction of the arrow b2, the blade edge 121a of the fixed blade 121 is spaced apart from the opposing surface of the movable blade 122, and the fixed blade 121 is rotated in a direction of an arrow a2 due to the elastic force of the compression coil spring 123 to be returned to a waiting position.

As described above, in the conventional sheet cutting device, at the time of cutting the sheet material, the fixed blade and the movable blade are allowed to intersect with each other in a state where the blade edges of the fixed blade and the movable blade are brought into press contact with each other. Therefore, the blade edge of the movable blade comes into sliding contact with the opposing surface of the fixed blade, and the blade edge of the fixed blade comes into sliding contact with the opposing surface of the movable blade. Thus, since the blade edges of the fixed blade and the movable blade come into sliding contact with each other, the conventional sheet cutting device wears easily, leading to a reduction in cutting performance, that is, poor durability.

Accordingly, in order to prevent the wear of the blade edges of the fixed blade and the movable blade, it is required to take measures including adoption of a special material having a relatively high degree of hardness as a forming material of those, application of a hardening treatment on surfaces of the blade edges, and the like. Therefore, with the conventional cutting device, there is a problem in which cost of the forming material for the fixed blade and the movable blade and manufacture costs involved in additional processes increase.

Further, in the conventional sheet cutting device, in order to cut the sheet material, the blade edges of the fixed blade and the movable blade are brought into press contact with each other. Therefore, the load caused by friction between the blade edges at the time of cutting is relatively large and an actuator such as a motor for generating a driving force corresponding to the load is required. Thus, in the conventional sheet cutting device, there is a disadvantage in which, for example, the actuator becomes larger, involving increase in costs of the actuator itself, thereby leading to an increase in size of the device as a whole.

In a case where the fixed blade and the movable blade are brought into press contact with each other, in order to suppress the wear of the blade edges, there is generally adopted a structure, in which, one of the fixed blade and the movable blade is curved in the thickness direction with respect to the other of those so that when the blade edges of the fixed blade and the movable blade intersect with each other, the blade edges come into contact with each other only at contact points in a cutting position.

For example, as shown in FIG. 12, the movable blade 122 is formed such that the central portion in the width direction of the blade edge 122a is curved in the thickness direction and the fixed blade 121 is formed to be flat. Alternatively, as for example, as shown in FIG. 13, the fixed blade 121 is formed such that the central portion in the width direction of the blade edge 121a is curved in the thickness direction and the movable blade 122 is formed to be flat.

Thus, in the conventional sheet cutting device, shapes of the fixed blade and the movable blade are complicated. Therefore, it is required to perform dimensional control to form the blades into the shapes, leading to an increase in manufacture costs.

By curving one of the fixed blade and the movable blade in the thickness direction, there is a problem in that a cut portion of the sheet material does not constitute a straight line. That is, in the sheet material, there is formed the cut portion inclined along the curve of the fixed blade or the movable blade.

### SUMMARY OF THE INVENTION

It is therefore an object of the present invention to provide a sheet cutting device capable of suppressing wear of blade edges of a fixed blade and a movable blade, increasing durability of cutting performance of the blade edges of the fixed blade and the movable blade, downsizing the device as a whole, and reducing manufacture costs, a printer, and a sheet cutting method.

In order to achieve the above-mentioned object, a sheet cutting device according to the present invention includes: a flat fixed blade; a flat movable blade having a blade edge which performs horizontal movement with respect to the fixed blade in directions approaching and departing from a blade edge of the fixed blade; a drive means for moving the movable blade with respect to the fixed blade; and gap forming means for forming a predetermined gap according to a thickness of the sheet material between the blade edges in a thickness direction of those when the blade edges of the fixed blade and the movable blade intersect with each other.

According to the sheet cutting device of the present invention structured as described above, when cutting the sheet material, the blade edge of the fixed blade and the blade edge of the movable blade intersect with each other in a non-contact state, and the sheet material is cut by the blade edges. That is, the blade edge of the fixed blade and the blade edge of the movable blade do not come into contact with each other, so wear of the blade edges are suppressed, thereby increasing durability of cutting performance.

Further, according to the sheet cutting device, the cutting is performed while the blade edge of the fixed blade and the blade edge of the movable blade do not come into contact with each other, thereby reducing a load generated when cutting the sheet material. Therefore, it is possible to downsize the drive means, which reduces manufacture costs.

Further, according to the sheet cutting device, the wear of the blade edges of the fixed blade and the movable blade is suppressed, thereby reducing the load generated when cutting the sheet material. Accordingly, it is possible to use the fixed blade and the movable blade with the blade edges of those being flat. Thus, it is not required to use a special component or to apply an additional finish to the blade edges, thereby reducing manufacture costs of the fixed blade and the movable blade.

Further, according to the sheet cutting device, the sheet material is cut by the flat fixed blade and the flat movable blade, so the cut portion of the sheet material is formed to be a straight line.

The gap forming means, provided to the sheet cutting device according to the present invention, preferably forms a gap which is equal to or smaller than a half of a thickness of the sheet material and is equal to or larger than 0.

Further, one of the fixed blade and the movable blade, provided to the sheet cutting device according to the present invention, preferably has an introduction portion for guiding the blade edge of one of the fixed blade and the movable blade in the thickness direction of the other of those. With this construction, the introduction portion provided to one of the fixed blade and the movable blade is brought into sliding contact with the other of those, thereby, when the blade edge of the fixed blade and the blade edge of the movable blade intersect with each other, making it possible to guide a position in the thickness direction of the one blade edge in the thickness direction of the other blade edge.

Further, the printer according to the present invention includes the above-described sheet cutting device of the present invention and the printing device for performing printing on the sheet material. In the printer, the sheet material on which printing is performed by the printing device and which is conveyed is cut by the sheet cutting device.

Further, according to the present invention, in a sheet cutting method of cutting a sheet material by allowing a movable blade to perform horizontal movement with respect to a fixed blade, blade edges of the flat movable blade intersects with the flat fixed blade, thereby performing cutting in a state where a predetermined gap according to a thickness of the sheet material is ensured in a thickness direction of the blade edges.

As described above, according to the present invention, the wear of the blade edges of the fixed blade and the movable blade is suppressed, so it is possible to increase the durability of cutting performance of the fixed blade and the movable blade, to downsize the device as a whole, and to reduce the manufacture costs. Further, according to the present invention, the sheet material is cut by the flat fixed blade and the flat movable blade, so it is possible to form the cut section of the sheet material in a straight line.

### BRIEF DESCRIPTION OF THE DRAWINGS

In the accompanying drawings:

FIG. 1 is a perspective view showing a printer of an embodiment of the present invention;

FIG. 2 are views of a printing device;

FIG. 3 are views of a sheet cutting device;

FIG. 4 are perspective views of a drive mechanism of the sheet cutting device;

FIG. 5 are perspective views of a fixed blade and a movable blade;

FIG. 6 are sectional views showing states in which a sheet material is cut by the fixed blade and the movable blade;

FIG. 7 is a graph illustrating a relationship between a positional relationship between the fixed blade and the movable blade in a thickness direction and a load required for cutting;

FIG. 8 are perspective views of a fixed blade and a movable blade according to another embodiment of the present invention;

FIG. 9 are sectional views of states in which a sheet material is cut by the fixed blade and the movable blade;

FIG. 10 is a perspective view of an example of another movable blade applicable to this embodiment;

FIG. 11 are sectional views of states in which a sheet material is cut by a fixed blade and a movable blade in a conventional sheet cutting device;

FIG. 12 is a perspective view of an example of a fixed blade and a movable blade of the conventional sheet cutting device; and

FIG. 13 is a perspective view of another example of a fixed blade and a movable blade of the conventional sheet cutting device.

### DETAILED DESCRIPTION OF THE PREFERRED EMBODIMENTS

Herein after, specific embodiments of the present invention will be described with reference to the drawings.

As a sheet material for use in a printer of this embodiment, there is used so-called heat sensitive paper sheet having a structure in which a thermal print layer is provided on a front surface side of a sheet-like base material. Further, in the printer of this embodiment, as the sheet material, there is used heat sensitive paper having a thickness of about 65 μm to about 125 μm, for example.

### First Embodiment

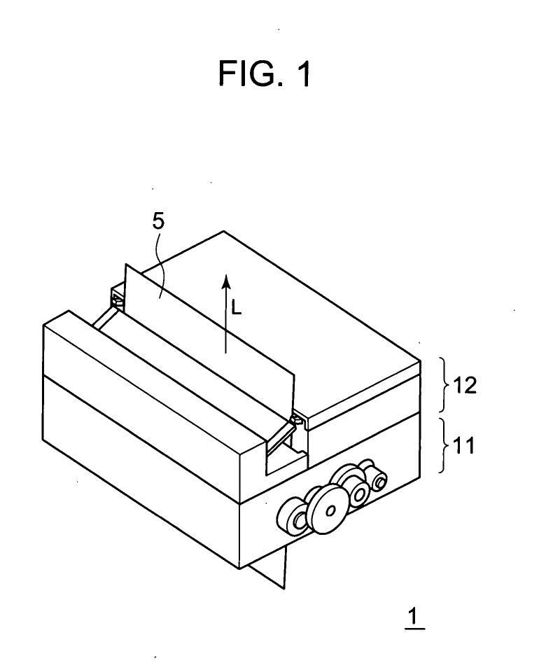

As shown in FIG. 1, a printer 1 includes a printing device 11 for performing printing on a sheet material 5 and conveying the sheet material 5, and a sheet cutting device 12 for cutting the sheet material 5 on which printing is performed by the printing device 11.

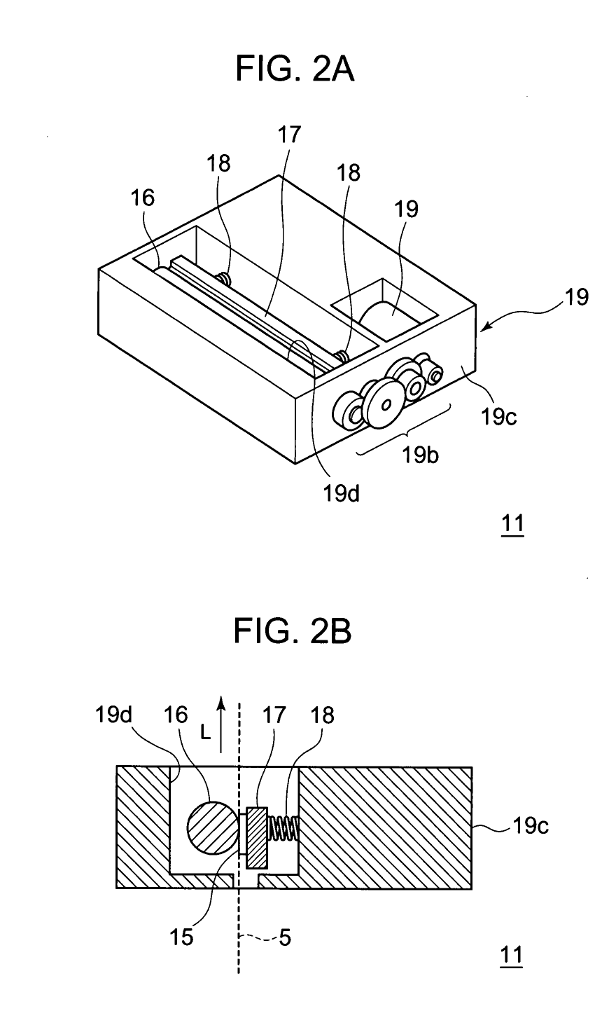

As shown in FIGS. 2A and 2B, for the printing device 11, a so-called thermal printer is used, and the printing device 11 includes thermal head 15 for allowing a heat sensitive print layer of the sheet material 5 to sense heat, a platen roller 16 brought into press contact with the thermal head 15, a head support body 17 for supporting the thermal head 15, a compression coil spring 18 for pressing the head support body 17 to the platen roller 16, and a drive mechanism 19 for rotating the platen roller 16.

The drive mechanism 19 includes a drive motor 19a, a gear train 19b for transmitting a driving force caused by the drive motor 19a to the platen roller 16, and a support block 19c for supporting the drive motor 19a and the gear train 19b. The support block 19c has an opening 19d formed therein through which the sheet material 5 conveyed by the platen roller 16 passes. In the opening 19d, there are arranged the platen roller 16 and the thermal head 15.

In the printing device 11, while the sheet material 5 fed from a sheet feeding device (not shown) having a sheet roll obtained by rolling the sheet material 5 is sandwiched between the thermal head 16 and the platen roller 17, printing is performed on the heat sensitive print layer of the sheet material 5, and at the same time, the sheet material 5 is conveyed upwards in FIG. 2 in a direction of an arrow L.

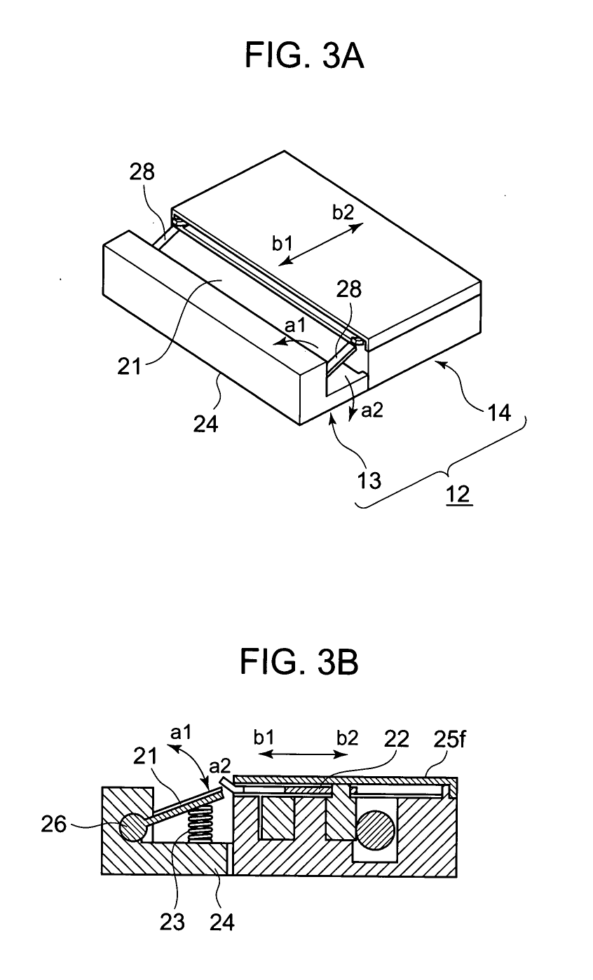

As shown in FIG. 3, the sheet cutting device 12 includes a fixed blade unit 13 having a fixed blade 21 and a movable blade unit 14 having a movable blade 22.

The fixed blade unit 13 includes the fixed blade 21 provided so as to be pivotable in directions of arrows a1 and a2 of FIGS. 3A-3B a compression coil spring 23 for pressing a blade edge 21a of the fixed blade 21 in the direction of the arrow a1, and a support block 24 for supporting the fixed blade 21.

The fixed blade 21 is formed of a flat plate-like material. The blade edge 21a is formed in a linear configuration. The blade edge 21a is arranged so as to be parallel to a width direction of the sheet material 5 conveyed in the direction of the arrow L. The fixed blade 21 has a pivot shaft 26 provided at one end thereof and is supported so as to freely rotate in the directions of the arrows a1 and a2 of FIGS. 3A-3B through the pivot shaft 26.

On opposite sides in a width direction of the blade edge 21a of the fixed blade 21, there are respectively provided spacers 28 serving as gap forming means for ensuring a predetermined gap, which corresponds to a thickness of the sheet material 5, between the blade edge 21a of the fixed blade 21 and a blade edge 22a of the movable blade 22. The spacers 28 are provided, on a surface of the fixed blade 21 opposed to the movable blade 22 and coming into sliding contact therewith, along directions of arrows b1 and b2, that is, moving directions of the movable blade 22.

The spacers 28 are set such that when cutting the sheet material 5, a gap t which is equal to or smaller than a half of the thickness of the sheet material and larger than 0 is ensured between the blade edge 21a of the fixed blade 21 and a blade edge 22a of the movable blade 22. As described later, in a case where a gap which is larger than a half of the thickness of the sheet material 5 is provided in a thickness direction of the blade edges 21a and 22a of the fixed blade 21 and the movable blade 22, respectively, it is difficult to cut the sheet material 5.

The spacers 28 are joined to the fixed blade 21 by, for example, spot welding or an adhesive. Further, the spacers 28 may be integrally formed on the opposing surface of the fixed blade 21.

The movable blade unit 14 includes the movable blade 22 allowed to perform horizontal movement with respect to the fixed blade 21 in the directions of the arrows b1 and b2 of FIGS. 3A-3B approaching and departing from the fixed blade 21, and a drive mechanism 25 for allowing the movable blade 22 to move with respect to the fixed blade 21.

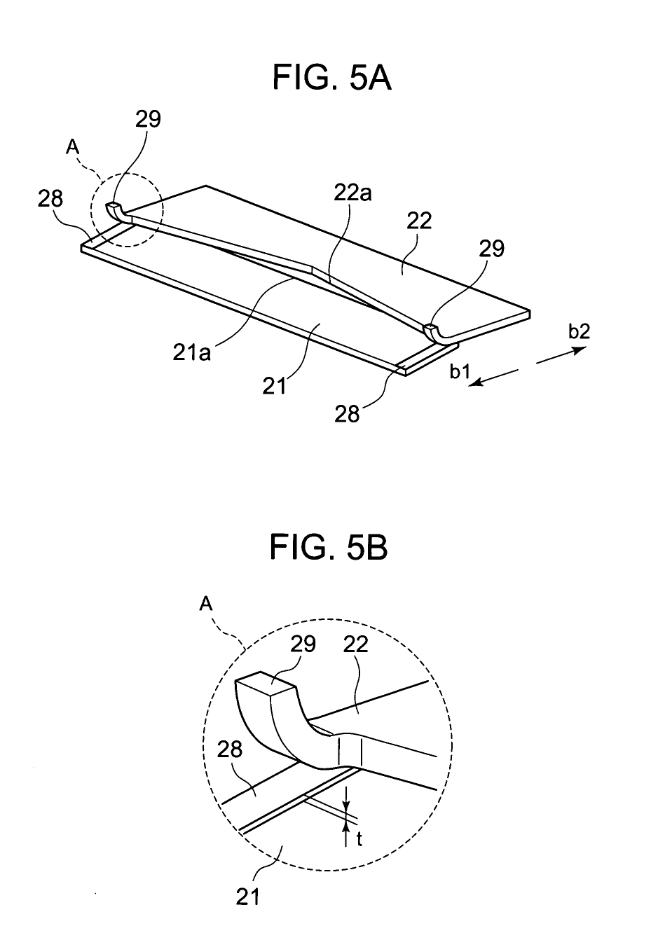

As shown in FIG. 5A, the movable blade 22 is formed of a flat plate-like material and has the blade edge 22a formed thereon. The blade edge 22a is formed in a substantially V-shaped configuration in which a central portion in the width direction thereof retracts in the direction of the arrow b2. As shown in a portion A of FIG. 5B, on opposite sides in the width direction of the blade edge 22a of the movable blade 22, there are respectively formed introduction portions 29 for guiding the fixed blade 21 in the thickness direction of the movable blade 22 when the fixed blade 21 and the movable blade 22 intersect with each other. Each of the introduction portions 29 is formed to curve in the thickness direction of the movable blade 22 and extends to a position opposed to the fixed blade 21 when the fixed blade 21 and the movable blade 22 are spaced apart from each other in waiting positions. Further, the movable blade 22 is supported at the opposite sides thereof in the width direction of the blade edge 22a by the drive mechanism 25 in a slidable manner.

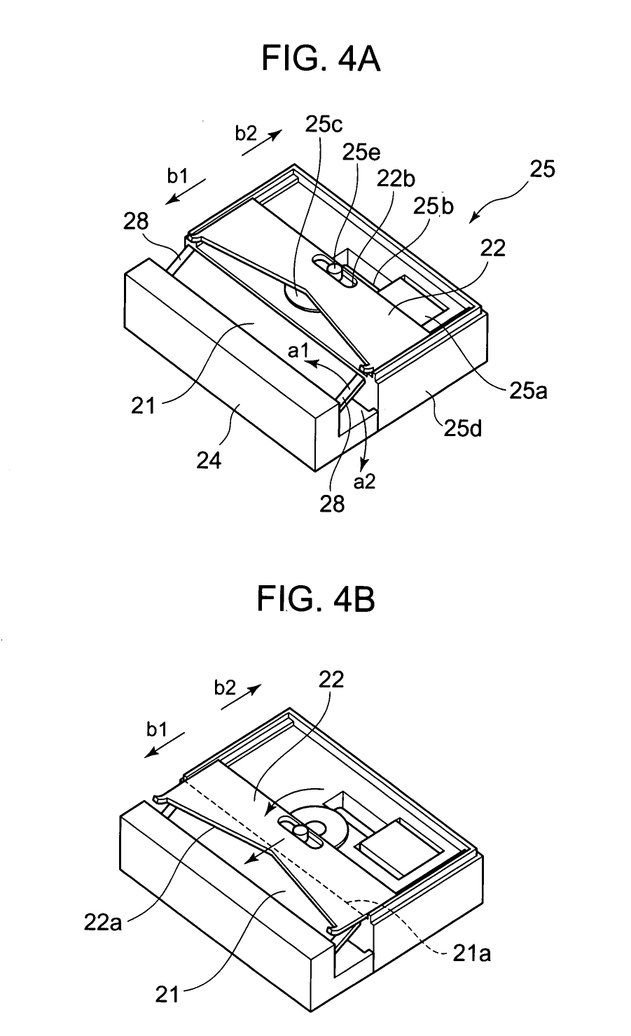

As shown in FIGS. 4A and 4B, the drive mechanism 25 includes a drive motor 25a, a worm 25b rotated by the drive motor 25a, a wheel 25c rotated by the worm 25b, and a support block 25d supporting the drive motor 25a, the worm 25b, and the wheel 25c.

Further, a cam protrusion 25e is integrally formed on the wheel 25c and is engaged with the movable blade 22. Further, a cam slit 22b, to which the cam protrusion 25e is engaged so as to be movable, is provided along the width direction of the blade edge 22a. Further, the movable blade 22 is guided in the directions of the arrows b1 and b2 by side walls of the support block 25d. As shown in FIG. 3B, the movable blade 22 is regulated with respect to the thickness direction thereof by a cover 25f. Thus, as shown in FIG. 4B, the movable blade 22 can slide only horizontally in the directions of the arrows b1 and b2.

Therefore, in the drive mechanism 25, the wheel 25c is rotated by the drive motor 25a through an intermediation of the worm 25b, thereby allowing the movable blade 22 to move parallelly in the directions of the arrows b1 and b2 by means of the cam protrusion 25e engaged with the cam slit 22b. The support block 25d is provided with guide grooves for supporting the opposite sides in the width direction of the movable blade 22 such that the movable blade 22 is movable.

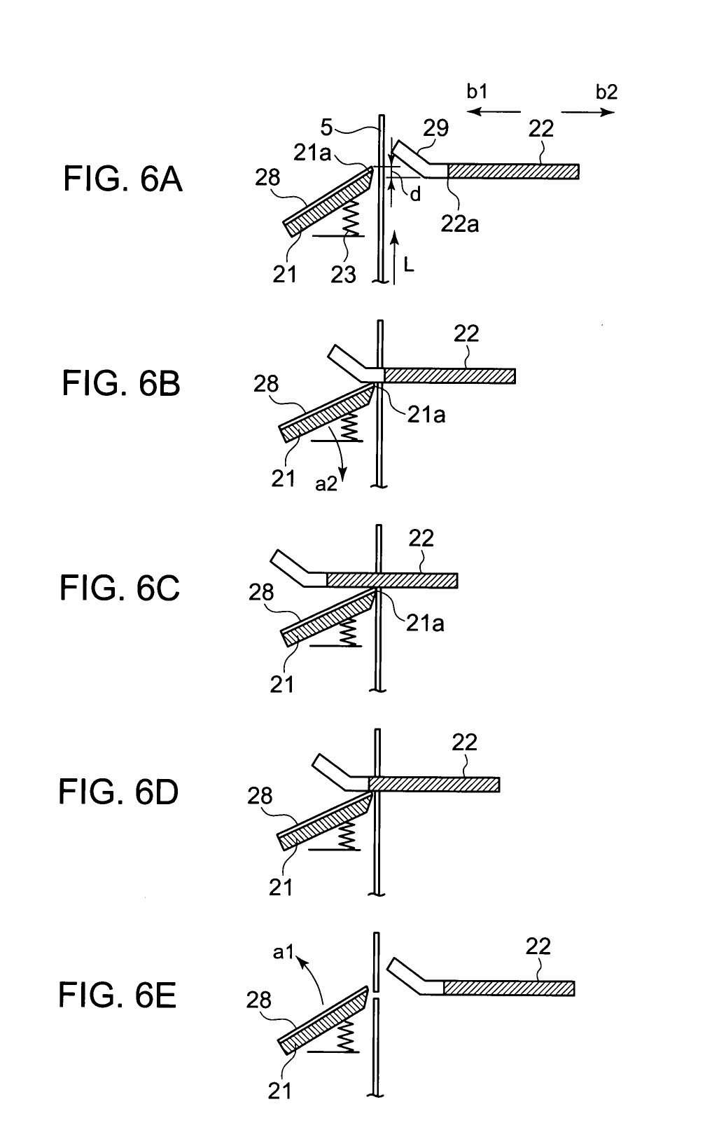

As shown in FIG. 6A, the blade edge 21a of the fixed blade 21 is set in a position where the blade edge 21a overlaps the blade edge 22a of the movable blade 22 in the thickness direction in the waiting position which is spaced apart from the blade edge 22a of the movable blade 22. In the waiting position, an overlap amount d between the spacers 28 of the fixed blade 21 and the blade edge 22a of the movable blade 22 in the thickness direction of the blade edge 22a, that is, a direction parallel to a conveying direction of the sheet material 5 only needs to be set larger than “0” mm.

In this embodiment, similarly to the conventional example, the overlap amount is set to be from, for example, about 0.4 mm to about 0.8 mm. The overlap amount d is ensured, thereby allowing the spacer 28 on the fixed blade 21 side to be reliably brought into sliding contact with the opposing surface of the movable blade 22. Thus, owing to the spacer 28, a predetermined gap can easily be ensured between the blade edges 21a and 22a.

When the fixed blade 21 and the movable blade 22 intersect with each other, the spacers 28 on both end sides of the fixed blade 21 are guided by the introduction portions 29 of the movable blade 22, and the blade edge 21a of the fixed blade 21 is moved in the thickness direction of the movable blade 22. The spacers 28 on the fixed blade 21 side come into sliding contact along the opposing surface of the movable blade 22, thereby making a predetermine gap between the fixed blade 21 and the movable blade 22.

With regard to the sheet cutting device 12 provided to the printer 1 structured as described above, an operation of cutting the sheet material 5 by the fixed blade 21 and the movable blade 22 will be described with reference to the drawings.

In the sheet cutting device 12, as shown in FIG. 6A, in awaiting state where the movable blade 22 is spaced apart from the fixed blade 21, the position of the blade edge 21a of the fixed blade 21 overlaps the position of the blade edge 22a of the movable blade 22 in the thickness direction of the blade edge 22a, that is, the conveying direction of the sheet material 5 by the overlap amount d.

The drive mechanism 25 allows the movable blade 22 to perform horizontal movement with respect to the fixed blade 21 in the direction of the arrow b1. Thus, the spacers 28 of the fixed blade 21 each come into sliding contact with the introduction portions 29 of the movable blade 22 to move along the introduction portions 29. As a result, as shown in FIG. 6B, the fixed blade 21 is rotated in the direction of the arrow a2 against an elastic force of the compression coil spring 23.

Next, as shown in FIG. 6C, the movable blade 22 further moves in the direction of the arrow b1, thereby allowing the spacers 28 of the fixed blade 21 to slide along the opposing surface of the movable blade 22. The blade edge 21a of the fixed blade 21 intersects with the blade edge 22a of the movable blade 22 in a non-contact state, thereby cutting the sheet material 5. At this time, cutting of the sheet material 5 by the blade edges 21a and 22a of the fixed blade 21 and the movable blade 22, respectively, is started at the opposite sides in the width direction thereof and is smoothly performed from the opposite sides toward the center thereof.

After the sheet material 5 has been cut, as shown in FIG. 6D, the movable blade 22 is moved in the direction of the arrow b2. Thus, the spacers 28 of the fixed blade 21 slide along the opposing surface of the movable blade 22 to enter the introduction portions 29.

As shown in FIG. 6E, after the spacers 28 of the fixed blade 21 enters the introduction portions 29 as the movable blade 22 is moved in the direction of the arrow b2, the fixed blade 21 is rotated in the direction of the arrow a2 by the elastic force of the compression coil spring 23 to be returned to the waiting position.

Next, with regard to the sheet cutting device, a relationship between a positional relationship between the blade edge of the fixed blade and the blade edge of the movable blade in the thickness direction, and a load required for cutting the sheet material will be described with reference to the drawings.

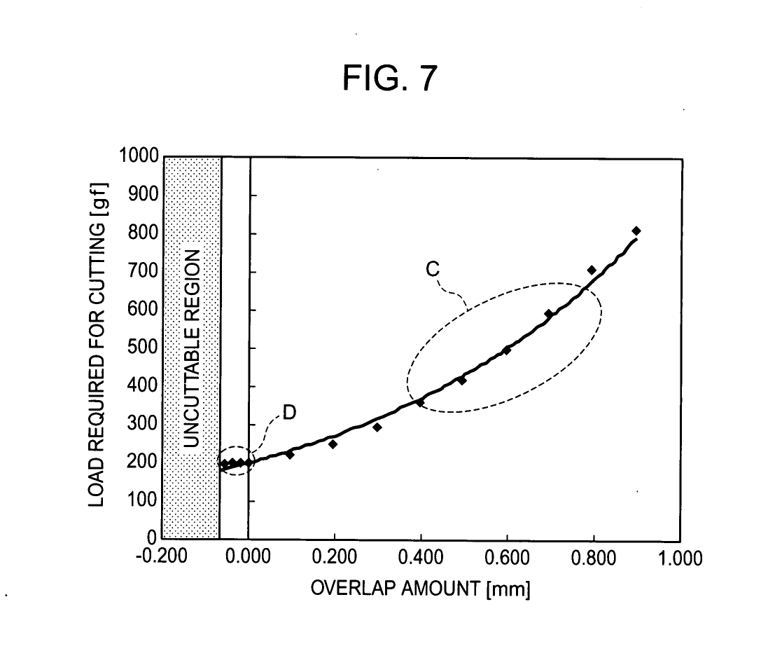

In the conventional sheet cutting device, the overlap amount by which the blade edges of the fixed blade and the movable blade overlap each other in the thickness direction thereof in the waiting positions is set to be about 0.4 mm to about 0.8 mm as shown in a range C surrounded by a broken line of FIG. 7. In a case where, as the sheet material, roll paper having a thickness of about 75 μm is cut, when cutting the sheet material, a load of about 350 gf to about 650 gf is caused on the movable blade side. Note that, this occurs only in a case where the elastic force of the compression coil spring 23 acting on the fixed blade is set to be about 400 gf.

On the other hand, in the sheet cutting device 12 of this embodiment, the sheet material 5 is cut when the blade edge 21a of the fixed blade 21 and the blade edge 22a of the movable blade 22 are in the non-contact state. Therefore, as shown in a range D surrounded by a broken line in FIG. 7, the overlap amount by which the blade edges 21a and 22a of the fixed blade 21 and the movable blade 22, respectively, overlap each other in the thickness direction thereof becomes smaller than “0” mm. Thus, when the sheet material is cut, a load of about 200 gf is caused on the movable blade side.

Further, in a case where a gap which is larger than a half of the thickness of the sheet material 5 is provided in the thickness direction of the blade edges 21a and 22a of the fixed blade 21 and the movable blade 22, respectively, as shown by an uncuttable region in FIG. 7, it is difficult to cut the sheet material 5.

As described above, according to the sheet cutting device 12, the load required to cut the sheet material 5 is significantly reduced, and it is possible to use, as the drive mechanism 25, a motor having a relatively small output.

Note that, in the sheet cutting device 12 of this embodiment, when the fixed blade 21 and the movable blade 22 intersect with each other, unlike in the conventional art in which the blade edges 21a and 22a of the fixed blade 21 and the movable blade 22, respectively, come into sliding contact with each other, the spacers 28 on the fixed blade 21 side and the opposing surface of the movable blade 22 come into sliding contact with each other. However, as compared to the sharp blade edges 21a and 22a, sliding contact surfaces of the spacers 28 which slide on the opposing surface of the movable blade allows sliding with wider smooth surfaces, so the load is dispersed. Accordingly, as compared to slid states of the conventional fixed blade and movable blade, the blade edges of which slide each other, wear of the spacers 28 is remarkably less. Further, even in a case where the spacers 28 are worn away through the sliding, a shift is caused such that the above-mentioned gap t diminishes, and a shift to the uncuttable region is not caused as shown in FIG. 7. Further, even if the spacers 28 are completely worn away, the blade edges 21a and 22a of the fixed blade 21 and the movable blade 22, respectively, come into sliding contact with each other like in the conventional art, so the cutting operation of the sheet material 5 is not interrupted.

As described above, according to the sheet cutting device 12, due to inclusion of the spacers 28 for ensuring, when the fixed blade 21 and the movable blade 22 intersect with each other, the gap between the blade edge 21a of the fixed blade 21 and the blade edge 22a of the movable blade 22 to be equal to or smaller than a half of the thickness of the sheet material 5, it is possible to cut the sheet material 5 when the blade edges 21a and 22a of the fixed blade 21 and the movable blade 22, respectively, are in the non-contact state. Thus, in the sheet cutting device 12, wear of the blade edges 21a and 22a of the fixed blade 21 and the movable blade 22, respectively, can be suppressed, thereby making it possible to increase durability of cutting performance of the blade edges 21a and 22a of the fixed blade 21 and the movable blade 22, respectively.

Further, in the sheet cutting device 12, when the fixed blade 21 and the movable blade 22 intersect with each other, the fixed blade 21 and the movable blade 22 do not come into sliding contact with each other over an entire region of the opposing surfaces of the fixed blade 21 the movable blade 22. Therefore, the blade edges 21a and 22a cut the sheet material 5 in the non-contact state, so the load at the time of cutting is reduced. The slide surfaces of the spacers 28 on the fixed blade 21 side come into sliding contact with the movable blade 22, but the spacers 28 slide on the smooth surfaces of those as described above. Therefore, sliding resistance at the time of cutting sheet is smaller than in the sliding between conventional blade edges. Thus, according to the sheet cutting device 12, it is possible to use a relatively small motor as the drive motor for driving the movable blade 22 against a slide resistance, thereby making it possible to downsize the sheet cutting device 12 as a whole and to reduce manufacture costs thereof.

Further, according to the sheet cutting device 12, the sheet material 5 is cut by the flat fixed blade 21 and the flat movable blade 22. Therefore, it is possible to form a cut portion of the sheet material 5 in a straight line.

### Second Embodiment

There will be described a second embodiment of the present invention in which spacers are provided on the movable blade 22 side unlike in the first embodiment adopting the structure in which the spacers 28 are provided on the fixed blade 21 side of the sheet cutting device 12. In the second embodiment, components identical to those of the above-mentioned first embodiment are denoted by the identical reference symbols and the description thereof will be omitted.

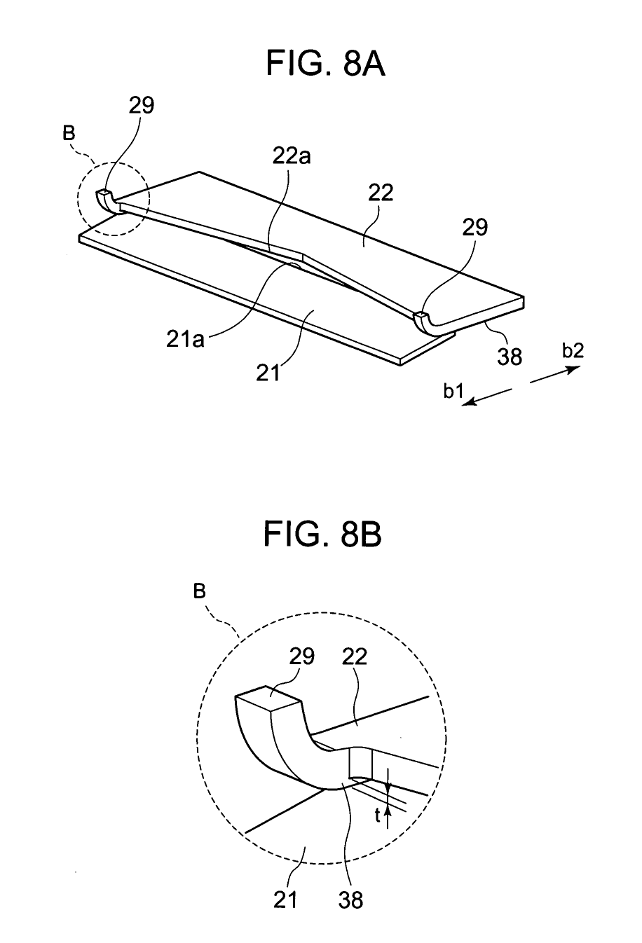

As shown in a portion B in each of FIGS. 8A and 8B, in the second embodiment, on the introduction portions 29 formed on the movable blade 22 provided to the sheet cutting device, spacers 38 to be brought into sliding contact with an opposing surface of the fixed blade 21 is provided.

Similarly to the spacers 28, the spacers 38 are formed so as to ensure the gap t equal to or smaller than a half of the thickness of the sheet material 5, and are joined to the introduction portions 29 of the movable blade 22 by, for example, spot welding or an adhesive. Further, the spacers 38 may be integrally formed on the introduction portions 29 of the movable blade 22.

With regard to the second embodiment structured as described above, an operation of cutting the sheet material 5 by the fixed blade 21 and the movable blade 22 will be described with reference to the drawings.

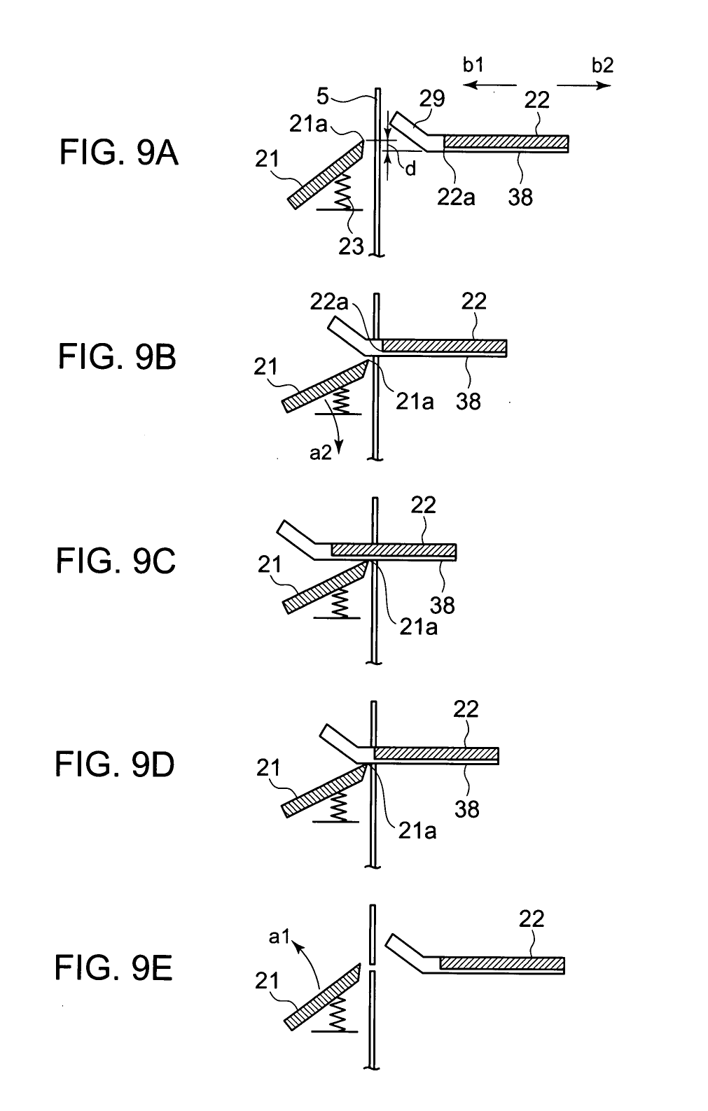

In the sheet cutting device, as shown in FIG. 9A, in a waiting state where the movable blade 22 is spaced apart from the fixed blade 21, the position of the blade edge 21a of the fixed blade 21 overlaps the position of the blade edge 22a of the movable blade 22 in the thickness direction of the blade edge 22a, that is, the conveying direction of the sheet material 5 by the overlap amount d.

The drive mechanism 25 allows the movable blade 22 to perform horizontal movement with respect to the fixed blade 21 in the direction of the arrow b1. Thus, the fixed blade 21 comes into sliding contact with the introduction portions 29 of the movable blade 22 to move along the introduction portions 29. As a result, as shown in FIG. 9B, the fixed blade 21 is rotated in the direction of the arrow a2 against the elastic force of the compression coil spring 23.

Next, as shown in FIG. 9C, the movable blade 22 further moves in the direction of the arrow b1, thereby allowing the fixed blade 21 to slide along the spacers 38 of the movable blade 22. The blade edge 21a of the fixed blade 21 intersects with the blade edge 22a of the movable blade 22 in a non-contact state, thereby cutting the sheet material 5. At this time, cutting of the sheet material 5 to be cut by the blade edges 21a and 22a of the fixed blade 21 and the movable blade 22, respectively, is started at the opposite sides in the width direction thereof and is smoothly performed from the opposite sides toward the center thereof.

After the sheet material 5 has been cut, as shown in FIG. 9D, the movable blade 22 is moved in the direction of the arrow b2. Thus, the fixed blade 21 slide along the spacers 38 of the movable blade 22 to enter the introduction portions 29.

As shown in FIG. 9E, after the fixed blade 21 enters the introduction portions 29 as the movable blade 22 is moved in the direction of the arrow b2, the fixed blade 21 is rotated in the direction of the arrow a2 by the elastic force of the compression coil spring 23 to be returned to the waiting position.

As described above, also in the second embodiment, like in the first embodiment, due to the inclusion of the spacers 38 which sets, when the fixed blade 21 and the movable blade 22 intersect with each other, the gap between the blade edge 21a of the fixed blade 21 and the blade edge 22a of the movable blade 22 to be equal to or smaller than a half of the thickness of the sheet material 5, it is possible to cut the sheet material 5 when the blade edges 21a and 22a of the fixed blade 21 and the movable blade 22, respectively, are in the non-contact state. Thus, also in the sheet cutting device of the second embodiment, wear of the blade edges 21a and 22a of the fixed blade 21 and the movable blade 22, respectively, can be suppressed, thereby making it possible to increase durability of cutting performance of the fixed blade 21 and the movable blade 22, respectively. Consequently, it is possible to downsize the device as a whole and to reduce the manufacture costs thereof.

The sheet cutting device according to the above-mentioned embodiments adopts the structure in which the spacers 28 and 38 are provided on one of the fixed blade 21 and the movable blade 22. However, the structure is not limited thereto. There may be adopted a structure in which spacers are provided to both the fixed blade and the movable blade as long as the gap in the thickness direction of the blade edges of the fixed blade and the movable blade is set to be equal to or smaller than a half of the thickness of the sheet material and larger than 0 when the fixed blade and the movable blade intersect with each other.

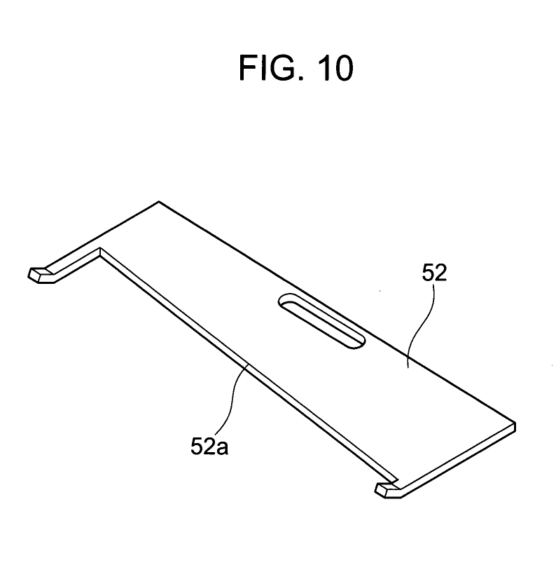

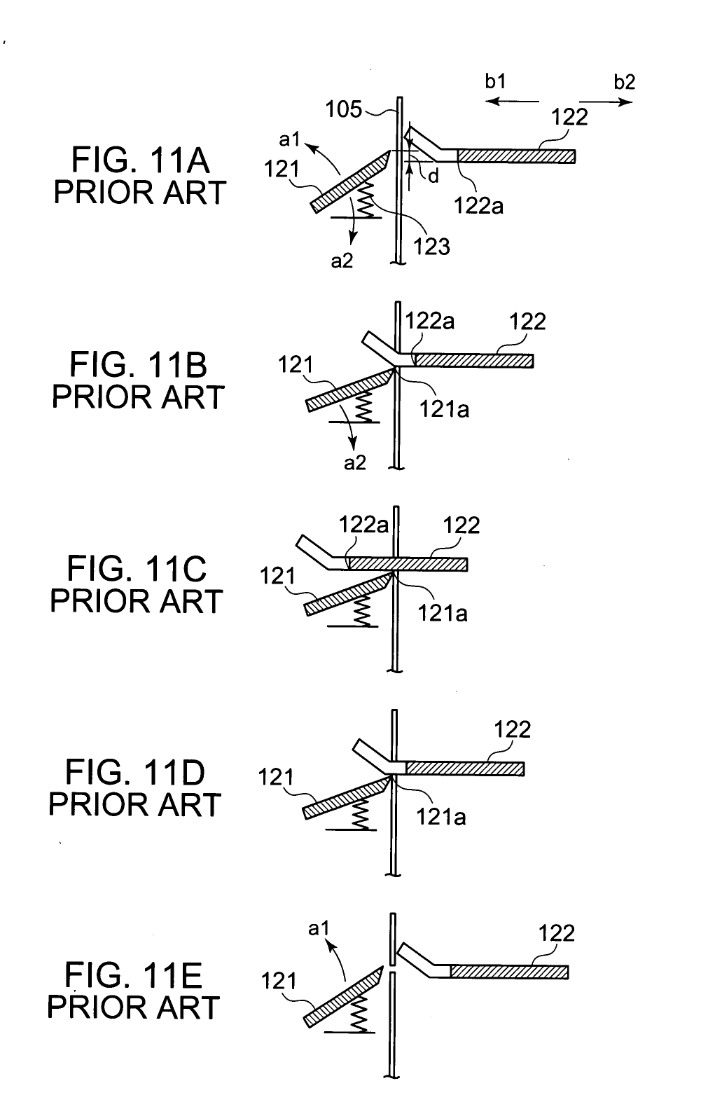

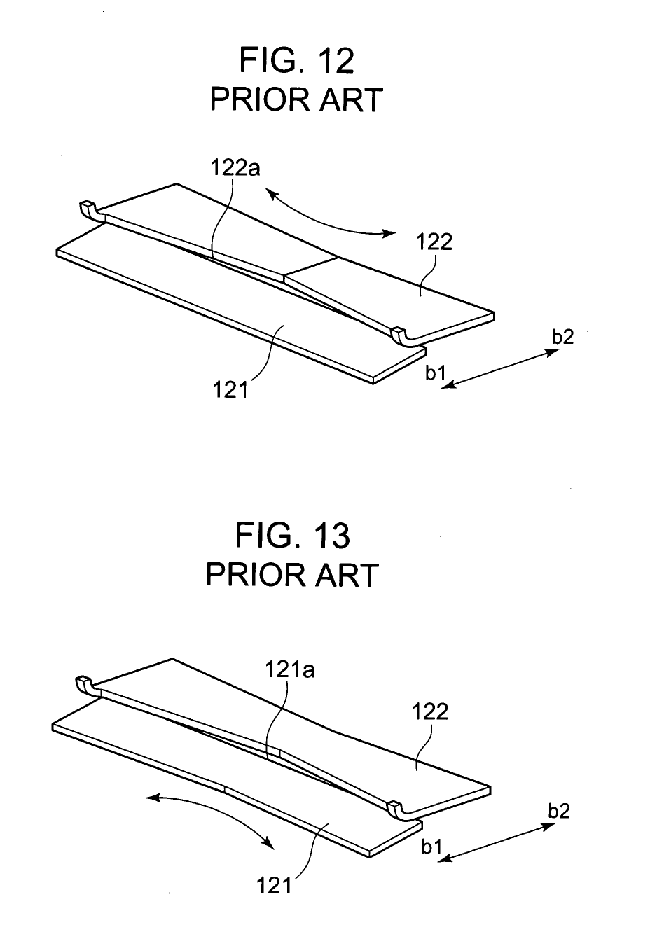

Further, the sheet cutting device according to the above-mentioned embodiments adopts the structure including the movable blade formed to have the substantially V-shaped blade edge. However, there may be used, for example, as shown in FIG. 10, a movable blade 52 having a blade edge 52a inclined with respect to the direction in which the movable blade 52 moves with respect to the fixed blade. As long as the movable blade has the shape capable of cutting the sheet material by intersecting with the fixed blade, an effect equivalent to that described above can be obtained even if the movable blade is formed in another shape as occasion needs.

What is claimed is:

1. A sheet cutting device, comprising:
a flat fixed blade;
a flat movable blade allowed to perform horizontal movement in directions approaching and departing from the fixed blade;
drive means for moving the movable blade with respect to the fixed blade; and
gap forming means for forming a predetermined gap according to a thickness of the sheet material between the blade edges of the fixed blade and the movable blade in a thickness direction of those when the blade edges intersect with each other.

2. A sheet cutting device according to claim 1, wherein the gap forming means forms a gap which is equal to or smaller than a half of a thickness of the sheet material, and is equal to or larger than 0.

3. A sheet cutting device according to claim 1, wherein the gap forming means comprises a spacer provided onto one of the fixed blade and the movable blade at its opposing surface and formed to have a thickness of the gap.

4. A sheet cutting device according to claim 3, wherein the spacers are integrally formed to protrude from the opposing surface of one of the fixed blade and the movable blade.

5. A sheet cutting device according to claim 3, wherein the spacers are provided on opposite sides in a width direction of the blade edge.

6. A sheet cutting device according to claim 1, wherein one of the fixed blade and the movable blade has an introduction portion for guiding the blade edge of one of the fixed blade and the movable blade in a thickness direction of the blade edge of another of the fixed blade and the movable blade.

7. A sheet cutting device according to claim 1, wherein the blade edge of the movable blade is formed in a concave shape in which a central portion in a width direction of the blade edge is retracted in a direction departing from the fixed blade.

8. A printer, comprising:
the sheet cutting device according to claim 1; and
a printing device for performing printing on a sheet material,
wherein the sheet material on which printing is performed by the printing device and is conveyed is cut by the sheet cutting device.

9. A sheet cutting method of cutting a sheet material by allowing a movable blade to perform horizontal movement with respect to a fixed blade, comprising cutting the sheet material in a state where a predetermined gap according to a thickness of the sheet material is ensured in a thickness direction of blade edges by allowing the blade edges of the flat movable blade and the flat fixed blade to intersect with each other.

10. A sheet cutting method according to claim 9, wherein the cutting is performed while ensuring the gap which is equal to or smaller than a half of the thickness of the sheet material and is equal to or larger than 0.
